(19) United States
(12) Patent Application Publication
(10) Pub. No.: US 2006/0030245 A1
(43) Pub. Date: Feb. 9, 2006

(54) Grindstone and method for producing optical element

(75) Inventor: Masami Masuko, Yokohamashi (JP)

Correspondence Address: MORGAN LEWIS & BOCKIUS LLP, 1111 PENNSYLVANIA AVENUE NW, WASHINGTON, DC, 20004, US

(73) Assignee: NIKON CORPORATION

(21) Appl. No.: 11/249,626

(22) Filed: Oct. 14, 2005

Related U.S. Application Data
(62) Division of application No. 10/865,899, filed on Jun. 14, 2004.
Application No. 10/865,899 is a continuation of application No. PCT/JP02/12856, filed on Dec. 9, 2002.

(30) Foreign Application Priority Data
Dec. 13, 2001 (JP) 2001-379581

(51) Int. Cl. B24B 1/00; B23F 21/03; B24B 33/00

(52) U.S. Cl. 451/41; 451/544

(57) ABSTRACT

A grindstone 1 has a pedestal 2 and an abrasive-grain layer 9 provided on the pedestal 2. The abrasive-grain layer 9 is a plating film which contains abrasive grains. An intermediate layer 7 which has physical properties different from those of the abrasive-grain layer 9 is provided between the abrasive-grain layer and the pedestal. The intermediate layer 7 is a plating film which contains abrasive grains, and the plating film of this intermediate layer 7 has a color tone different from the color tone of the plating film of the abrasive-grain layer 9. As being so made up, in the grindstone having an abrasive-grain layer formed of a plating film as a binder, the grindstone lifetime can be judged with ease.

### TECHNICAL FIELD

This invention relates to a grindstone used in grinding and polishing glass, metal or the like, and a method for producing an optical element by using this grindstone.

### BACKGROUND ART

A grindstone using a plating film as a binder of abrasive grains is known in the art. This grindstone has a structure in which an abrasive-grain layer formed of a plating film with abrasive grains dispersed therein is provided on a pedestal made of a metal. In producing this grindstone, first the surface of the pedestal is subjected to stated degreasing treatment and activation treatment, and the resultant pedestal is put into a plating solution to carry out plating. In this plating, abrasive grains are included in the plating solution, whereby a plating film having held therein the abrasive grains can be formed to form an abrasive-grain layer. This grindstone is used in various grinding and polishing, like a grindstone making use of a resin bond or a metal bond as a binder.

In the grindstone making use of such a plating film as a binder, the abrasive-grain layer wears gradually as a result of grinding or polishing, whereupon the pedestal surface comes to stand exposed finally. However, it is difficult to recognize the wear of this abrasive-grain layer, and it comes into question that the end of grindstone lifetime cannot be ascertained. In the conventional grindstone making use of a resin bond or a metal bond as a binder, the whole in its thickness direction is held by the abrasive-grain layer, and hence the lifetime of the grindstone can visually be judged with ease. However, in the case of the grindstone making use of the plating film as a binder, it is difficult to visually recognize the boundary between the pedestal and the abrasive-grain layer because the abrasive-grain layer is provided on the pedestal made of a metal. If the pedestal surface just comes exposed at the time when the abrasive-grain layer has completed the working of a workpiece, the wear of the abrasive-grain layer may be recognized when the workpiece is changed, and then the grindstone may be replaced. In most cases, however, the pedestal surface comes exposed on the way of working. Hence, the workpiece surface may come into contact with it, whereupon the workpiece may deeply be scratched on its surface or the workpiece may break, resulting in defectives for which any reworking is impossible. The pedestal itself may also be scratched, and hence the pedestal comes unable to be again used in some cases.

### DISCLOSURE OF THE INVENTION

An object of the present invention is to provide a grindstone having an abrasive-grain layer formed of a plating film as a binder, and is a grindstone which enables the grindstone lifetime to be easily recognized, and provide a method for producing an optical element by using this grindstone, and a method for producing a projection exposure device.

To achieve the above object, in the present application, the invention provides a grindstone as described below.

That is, it is a grindstone comprising a pedestal and
an abrasive-grain layer provided on the pedestal; wherein,
the abrasive-grain layer is a plating film which contains abrasive grains; and
an intermediate layer which has physical properties different from those of the abrasive-grain layer is provided between the abrasive-grain layer and the pedestal.

In the present application, the invention also provides a grindstone as described below.

That is, it is a grindstone comprising a pedestal and an abrasive-grain layer provided on the pedestal; wherein, the abrasive-grain layer is a plating film which contains abrasive grains; and
an intermediate layer which has optical characteristics different from those of the abrasive-grain layer is disposed between the abrasive-grain layer and the pedestal.

In the above grindstone, it may be so made up that the intermediate layer is a plating film which contains abrasive grains and the plating film has a color tone different from the color tone of the said plating film of said abrasive-grain.

In the above grindstone, it may be so made up that the plating film consisting of the intermediate layer is a black nickel plating film and aid plating film of said abrasive-grain is a silver white plating film.

In the above grindstone, the plating film consisting of the intermediate layer and said plating film consisting of said abrasive-grain may be so made up that one of them is a nickel plating film and the other is a copper plating film.

In the present application, the invention still also provides a grindstone as described below.

That is, it is a grindstone comprising a pedestal and an abrasive-grain layer provided on the pedestal; wherein, the abrasive-grain layer is a plating film which contains abrasive grains; and
an intermediate layer which has a coefficient of dynamic friction to a workpiece, different from that of the abrasive-grain layer is disposed between the abrasive-grain layer and the pedestal.

In the above grindstone, it may be so made up that the intermediate layer is a plating film which contains abrasive grains and the plating film has a hardness different from the hardness of aid plating film of said abrasive-grain.

In the above grindstone, it may be so made up that the intermediate layer is a plating film which contains abrasive grains and the plating film is different from the abrasive-grain layer in at least one of a particle diameter and a density of the abrasive grains contained.

According to the foregoing inventions, the grindstone can be provided, which has an abrasive-grain layer formed of a plating film as a binder and is a grindstone which enables the grindstone lifetime to be easily recognized.

To achieve the above object, in the present application, the invention also provides a method for producing an optical element, as described below.

That is, it is a method for producing an optical element by working a workpiece, wherein;
the workpiece is worked by means of a grindstone; and
the grindstone is used which has a pedestal, an abrasive-grain layer provided on the pedestal and formed of a plating film containing abrasive grains, and an intermediate layer provided between the pedestal and the abrasive-grain layer and having physical properties different from those of the abrasive-grain layer; the physical properties being inclusive of coefficient of dynamic friction to the workpiece and optical characteristics.

To achieve the above object, in the present application, the invention still also provides a method for producing a projection exposure device, as described below.

That is, it is a method for producing a projection exposure device having an optical system comprising a lens, wherein;
the grindstone is prepared which has a pedestal, an abrasive-grain layer provided on the pedestal and formed of a plating film containing abrasive grains, and an intermediate layer provided between the pedestal and the abrasive-grain layer and having physical properties different from those of the abrasive-grain layer; the physical properties being inclusive of coefficient of dynamic friction to a lens material, and optical characteristics; and
the lens material is worked by means of the grindstone, and the lens obtained by the working of the lens material is set in the optical system.

### BRIEF DESCRIPTION OF THE DRAWINGS

FIG. 1 is an illustration showing the structure of a grindstone of First Embodiment and Example 1 according to the present invention.

FIGS. 2 (a) to (e) are illustrations showing a method for producing the grindstone of Example 1 according to the present invention.

FIG. 3 is an illustration showing the structure of a grindstone of Example 2 according to the present invention.

FIGS. 4 (a) to (d) are illustrations showing a method for producing the grindstone of Example 2 according to the present invention (first presentation).

FIGS. 5 (e) to (g) are illustrations showing a method for producing the grindstone of Example 2 according to the present invention (second presentation).

FIG. 6 is an illustration showing the structure of a grindstone of Example 3 according to the present invention.

FIGS. 7 (a) to (e) are illustrations showing a method for producing the grindstone of Example 3 according to the present invention.

FIG. 8 (a) is an illustration showing how a surface abrasive-grain layer in Example 3 according to the present invention changes, and FIG. 8 (b) is an illustration showing how an intermediate abrasive-grain layer in Example 3 according to the present invention changes.

FIG. 9 is a perspective view of a working tool in Second Embodiment according to the present invention.

FIGS. 10 (a) and (b) are illustrations showing a first method for producing the working tool in Second Embodiment according to the present invention.

FIGS. 11 (a) and (b) are illustrations showing a second method for producing the working tool in Second Embodiment according to the present invention.

FIG. 12 (a) and (b) are illustrations showing a method for producing an optical element in Third Embodiment according to the present invention.

FIG. 13 is a structural view of a projection exposure device in Fourth Embodiment according to the present invention.

### BEST MODES FOR PRACTICING THE INVENTION

Various embodiments according to the present invention are described below with reference to the drawings.

### First Embodiment

First Embodiment according to the present invention is described first.

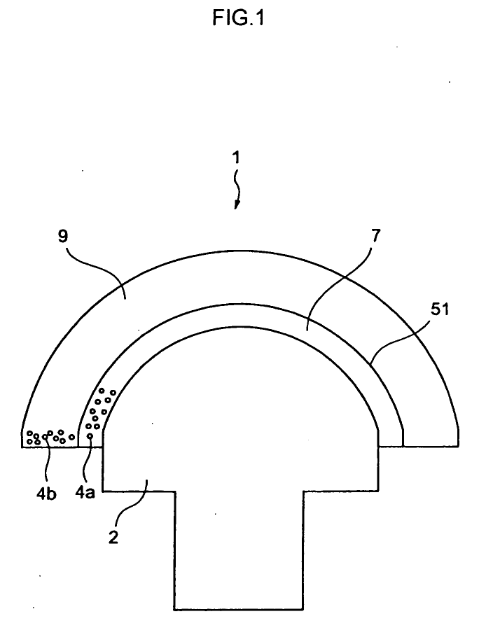

A grindstone in this embodiment has a structure in which, as shown in FIG. 1, an intermediate abrasive-grain layer 7 and a surface abrasive-grain layer 9 are superposed in order, on a pedestal 2. The intermediate abrasive-grain layer 7 and the surface abrasive-grain layer 9 are both abrasive-grain layers, utilized plating films as binders with which abrasive grains 4a and 4b have been bound. The intermediate abrasive-grain layer 7 and the surface abrasive-grain layer 9 are so made up that at least one of physical properties such as optical characteristics and coefficient of dynamic friction differ from each other in order to make it possible to recognize a boundary 51 between the both.

For example, the intermediate abrasive-grain layer 7 and the surface abrasive-grain layer 9 may be so made up that each of them utilizes as a binder a plating film having different optical characteristics such as reflectance and absorption wavelength. In this case, differences in hues (color tone and tint), chroma, brightness, gloss and so forth between the intermediate abrasive-grain layer 7 and the surface abrasive-grain layer 9 may be ascertained with the naked eye, or wavetength distribution of reflection may be ascertained with a measuring instrument, to recognize the boundary 51 between the intermediate abrasive-grain layer 7 and the surface abrasive-grain layer 9. In order to make the plating films having different reflectance and absorption wavelength, the types of chief component metals constituting the plating films may be made different each other. For example, an electroless nickel plating film is known as a plating film which takes on a color tone of black. Also, an electrolytic or electroless nickel plating film, an electrolytic tin plating film, an electrolytic lead plating film, an electrolytic iron plating film, an electrolytic silver color plating film and an electrolytic zinc plating film are available as plating films which take on a color tone of silver white. An electrolytic copper plating film is also known as a plating film which takes on a color tone of brown, and an electrolytic gold plating film is also known as a plating film which takes on a color tone of gold. Thus, for example, a black electroless nickel plating film may be used as the plating film consisting of the intermediate abrasive-grain layer 7, and a silver white electroless nickel plating film may be used as the plating film consisting of the surface abrasive-grain layer 9. As another example, a silver white electroless nickel plating film may be used as the plating film of the intermediate abrasive-grain layer 7, and a brown copper plating film may be used as the plating film consisting of the surface abrasive-grain layer 9. In these cases, it may be ascertained by visual observation of the surface of the grindstone 1 whether the surface abrasive-grain layer 9 has worn and the different intermediate abrasive-grain layer 7 has come exposed or not. Thus, it can be recognized that the surface abrasive-grain layer 9 has worn to come up to the end of the lifetime of the grindstone 1.

Examples of plating solutions (plating baths) which can form the above various-color plating films are shown in Table 1 below.

TABLE 1

| Hue | Type of plating film & plating solution (bath) |
|---|---|
| Black | Electroless nickel plating |
| | Trade name: KANIBLACK SKZ (available from Japan |
| | Kanigen Co., Ltd.): HV250 |
| Silver | (1) Nickel plating |
| | \textcircled{1} Electrolytic plating: |
| | Watts nickel bath composed chiefly of nickel sulfate |
| | and nickel chloride: HV150. |
| | Nickel sulfamate bath composed chiefly of nickel |
| | sulfamate: HV200. |
| | Nickel chloride bath composed chiefly of nickel |
| | chloride: HV230. |
| | {circle around (2Electroless plating: |
| | Nickel-phosphorus plating bath composed chiefly of |
| | nickel sulfate or nickel chloride and using a |
| | hypophosphite as a reducing agent: HV500 |
| | (containing about 9% of phosphorus), |
| | HV650 (containing about 3% of phosphorus). |
| | Nickel-boron plating bath using a borohydride as a |
| | reducing agent: HV800. |
| | (2) Tin plating: All electrolytic plating. |
| | Plating bath composed chiefly of stannous sulfate: HV5. |
| | Plating bath composed chiefly of stannous borofluoride. |
| | Plating bath composed chiefly of potassium stannate. |
| | Plating bath composed chiefly of sodium stannate. |
| | (3) Lead plating: All electrolytic plating. |
| | Plating bath composed chiefly of borofluoric acid. |
| | Plating bath composed chiefly of sulfamic acid. |
| | Plating bath composed chiefly of metasulfonic acid. |
| | (4) Iron plating: All electrolytic plating. |
| | Plating bath composed chiefly of ferrous chloride: HV120. |
| | Plating bath composed chiefly of ferrous sulfate: HV180. |
| | Plating bath composed chiefly of ferrous borofluoride. |
| | Plating bath composed chiefly of ferrous sulfamate. |
| | (5) Silver plating: Electrolytic plating bath composed |
| | chiefly of silver cyanide. |
| | (6) Zinc plating: All electrolytic plating. |
| | Plating bath composed chiefly of zinc cyanide: HV60. |
| | Plating bath composed chiefly of zinc chloride: HV60. |
| | Plating bath composed chiefly of zinc sulfate. |
| | Copper plating: All electrolytic plating. |
| Brown | Plating bath composed chiefly of copper sulfate: HV50. |
| | Plating bath composed chiefly of copper pyrophosphate: |
| | HV160. |
| | Plating bath composed chiefly of copper cyanide: HV100. |
| | Gold plating: Electrolytic plating. |
| Gold | Plating bath composed chiefly of gold cyanide: HK50 |
| | (Knoop hardness). |

Remarks: HV represents Vickers hardness of the plating film, and HK, Knoop hardness of the plating film.

Even where the metal is the same, it is also possible to make wavelength distribution of reflectance or absorption different by a method in which, e.g., the additives put into the plating solution are made different in concentration. In this case, for example, a difference in gloss may visually be recognized, or the wavelength distribution of reflectance or absorption in the surface of the grindstone 1 or that of waste liquor may be measured with a measuring instrument, to recognize the boundary between the intermediate abrasive-grain layer 7 and the surface abrasive-grain layer 9.

Abrasive grains having optical characteristics different from one another may also be used as the abrasive grains of the intermediate abrasive-grain layer 7 and the surface abrasive-grain layer 9 to make the intermediate abrasive-grain layer 7 and the surface abrasive-grain layer 9 have different wavelength distribution of reflectance or absorption so that the boundary 51 between the intermediate abrasive-grain layer 7 and the surface abrasive-grain layer 9 can be recognized.

The intermediate abrasive-grain layer 7 and the surface abrasive-grain layer 9 may also be so made up that plating films having different hardness are used as binders. As shown in Table 1 above, the hardness of plating films differ depending on materials for plating films, and besides even plating films formed of the same material differ in hardness depending on plating solutions (plating baths) and plating methods (electroless plating or electrolytic plating). Additives as shown in Table 2 below may also be added to the plating solutions shown in Table 1, to make plating films have different hardness. Table 2 shows examples of additives, where the hardness may be controlled by changing the types or addition concentration of the additives. Accordingly, plating films which differ in materials between the intermediate abrasive-grain layer 7 and the surface abrasive-grain layer 9 may be used, or plating films formed of the same material may be formed using different plating solutions or by different plating methods, to make the intermediate abrasive-grain layer 7 and the surface abrasive-grain layer 9 having hardness different from each other. Thus, the intermediate abrasive-grain layer 7 and the surface abrasive-grain layer 9 may be so made up that the hardness of plating films may differ between them. This makes the intermediate abrasive-grain layer 7 and the surface abrasive-grain layer 9 have values different in coefficient of dynamic friction to workpiece. Hence, the revolution torque of the grindstone 1 may be measured when the working such as grinding or polishing is carried out using the grindstone of this embodiment, to recognize the boundary 51 between the intermediate abrasive-grain layer 7 and the surface abrasive-grain layer 9. Incidentally, plating films formed of the same material may also be made to have different hardness by a method in which, e.g., the temperature of plating solutions is changed at the time of plating or the value of electric current is changed in the case of the electroless plating.

TABLE 2

| Type of plating | | Hardness |
|---|---|---|
| solution | Additive | (HV) |
| Nickel sulfamate | Sodium saccarinate 1 g/L | 400 |
| Watts nickel | NYSTAR 80M (trade name, available | 680 |
| | from C. Uyemura & Co., Ltd.) | |
| Copper sulfate | CUBELITE HS (trade name, available | 150 |
| | from Ebara-Udylite Co., Ltd.) | |
| Tin sulfate | Sn-222 (trade name, available | 40 |
| | from Dipsol Chemicals Co., Ltd.) | |

The intermediate abrasive-grain layer 7 and the surface abrasive-grain layer 9 may also be so made up that they differ in at least one of particle diameter and density of abrasive grains of the abrasive grains 4a and abrasive grains 4b to be contained in these layers. This makes the intermediate abrasive-grain layer 7 and the surface abrasive-grain layer 9 have values different in coefficient of dynamic friction to workpiece. Hence, the revolution torque may be measured when the working such as grinding or polishing is carried out using the grindstone of this embodiment, to recognize the boundary 51 between the intermediate abrasive-grain layer 7 and the surface abrasive-grain layer 9. Incidentally, the particle diameter of the abrasive grains 4a and 4b to be contained in the intermediate abrasive-grain layer 7 and the surface abrasive-grain layer 9, respectively, depends on the size of the abrasive grains to be put into plating solutions. Hence, the size of the abrasive grains to be put into it may be made different so that the particle diameter of the abrasive grains 4a for the intermediate abrasive-grain layer 7 and the particle diameter of the abrasive grains 4b for the surface abrasive-grain layer 9 differ from each other. Also, the density of abrasive grains in the intermediate abrasive-grain layer 7 and the surface abrasive-grain layer 9 may be controlled by changing the quantity of the abrasive grains to be put into plating solutions. For example, abrasive grains having the particle diameter and used in the amount as shown in Table 3 below may be put into the plating solutions shown in Table 1, whereby abrasive-grain layers can be formed in which abrasive grains are contained in plating films in the proportions shown in Table 3. Thus, the amount of abrasive grains to be put into plating solutions may be controlled in accordance with the desired density (content) of the abrasive grains to change the density of abrasive grains in plating films to be formed, to make the intermediate abrasive-grain layer 7 and the surface abrasive-grain layer 9 different in coefficient of dynamic friction to workpiece.

TABLE 3

| | | | Content of |
|---|---|---|---|
| | Abrasive grains | | abrasive grains |
| | (diamond) size and | | in abrasive |
| Type of plating solution | amount | | grain layer |
| Black electroless nickel | 2-4 μm | 0.1 wt % | 20 vol. % |
| ″ | ″ | 0.2 wt % | 30 vol. % |
| Electroless nickel- | 2-4 μm | 0.05 wt % | 15 vol. % |
| phosphorus plating (P: 9%) | | | |
| Electroless nickel- | ″ | 0.1 wt % | 25 vol. % |
| phosphorus plating (P: 9%) | | | |
| Electroless nickel- | ″ | 0.05 wt % | 20 vol. % |
| phosphorus plating (P: 3%) | | | |
| Electroless nickel- | ″ | 0.1 wt % | 30 vol. % |
| phosphorus plating (P: 9%) | | | |
| Nickel sulfamate plating | 12-25 μm | 0.1 wt % | 25 vol. % |
| ″ | ″ | 0.2 wt % | 35 vol. % |
| Copper sulfate plating | 2-6 μm | 0.1 wt % | 10 vol. % |
| ″ | | 0.2 wt % | 20 vol. % |

Incidentally, the thickness of the surface abrasive-grain layer 9 of the grindstone 1 is designed to be the thickness of which workpieces in desired number can be abraded or polished, e.g., a thickness of hundreds of micrometers (μm). On the other hand, the thickness of the intermediate abrasive-grain layer 7 may preferably be the thickness of which at least one workpiece can be worked. Thus, where it has been recognized by visual observation or with a measuring instrument that the surface abrasive-grain layer 9 has worn and the intermediate abrasive-grain layer 7 has come exposed, a procedure can be taken in which the working is continued as it is until the working of a workpiece being worked is completed, and thereafter the grindstone 1 is replaced. This enables enhancement of operating efficiency. Even though such a procedure is taken, the pedestal 2 may by no means come exposed during the working continued, because the thickness of the intermediate abrasive-grain layer 7 is in the thickness that enables at least one workpiece to be worked, making it possible to prevent the pedestal 2 from scratching the workpiece. For example, the thickness of the intermediate abrasive-grain layer 7 may be about tens of micrometers (μm).

A procedure of producing the grindstone 1 of this embodiment is described below.

First, a pedestal 2 is worked to become the shape, which is corresponding to the desired shape and dimensions of a workpiece and standing reverse to the shape of the workpiece. As a material for the pedestal 2, a metal is suitable because it can retain mechanical rigidity. For example, iron or brass may be used because it can make plating pretreatment easy. In the case when the intermediate abrasive-grain layer 7 is formed by electroless plating, the pedestal 2 may be made of iron, whereby the plating can be carried out without imparting any catalyst because the pedestal 2 itself serves as a catalyst. A catalyst may also be imparted so that any of aluminum, brass, stainless steel and resin can be used as the pedestal 2.

Next, as pretreatment of the plating, the pedestal 2 is degreased with a solvent, followed by masking except for the part where the abrasive-grain layers 7 and 9 are to be formed. Incidentally, in the case when the intermediate abrasive-grain layer 7 is formed by electroless plating, the whole pedestal 2 is subjected to stated alkali degreasing and activation treatment. Where a pedestal 2 not having any catalyst that accelerates the reaction of electroless plating is used, a catalyst layer is further formed. To form the catalyst layer, where the pedestal 2 is made of brass or stainless steel, the pedestal 2 is immersed in an aqueous solution composed chiefly of palladium chloride to form on the pedestal surface a palladium layer serving as a catalyst layer.

Next, abrasive grains with desired grain particle and in desired quantity are put into a plating solution selected beforehand, to form the intermediate abrasive-grain layer 7 by electrolytic plating or electroless plating. Stated specifically, in the case when the intermediate abrasive-grain layer 7 is formed by electroless plating, abrasive grains 4a such as diamond powder having the desired particle diameter are put into the plating solution selected beforehand, followed by stirring by means of a stirrer or the like to make the abrasive grains dispersed uniformly, during which the pedestal 2 is put into it. Thus, a film containing abrasive grains is formed only at the part where the surface of the pedestal 2 stands exposed, so that the intermediate abrasive-grain layer 7 can be formed. The thickness of the intermediate abrasive-grain layer 7 is so controlled as to have the desired thickness, by controlling plating conditions such as plating solution temperature and plating time. The content of the abrasive grains 4a in the intermediate abrasive-grain layer 7 may also be controlled by controlling the quantity of the abrasive grains to be put into the plating solution and the stirring conditions of the stirrer. Meanwhile, in the case when the intermediate abrasive-grain layer 7 is formed by electrolytic plating, the intermediate abrasive-grain layer 7 may in some cases be not formed uniformly after the shape of the pedestal 2 because of characteristics in the electrolytic plating. Accordingly, it is preferable to make shape correction by mechanical working after the intermediate abrasive-grain layer 7 has been formed. In the case of the electrolytic plating, the thickness of the intermediate abrasive-grain layer 7 to be formed is controlled by chiefly controlling the rate of electric current and plating time.

Next, the surface abrasive-grain layer 9 is formed on the intermediate abrasive-grain layer 7. In the case when the electroless plating is used to form the surface abrasive-grain layer 9, and where the intermediate abrasive-grain layer 7 makes use of a black or silver color nickel plating film as the binder, the intermediate abrasive-grain layer 7 itself acts as a catalyst that accelerates the reaction of electroless plating for the surface abrasive-grain layer 9, and hence any particular pretreatment is unnecessary. However, where the intermediate abrasive-grain layer 7 makes use of a copper plating film as the binder, palladium nuclei are formed as a catalyst layer like the case when it is done in the pretreatment for forming the intermediate abrasive-grain layer 7. Thereafter, the surface abrasive-grain layer 9 is formed by electrolytic plating. On the other hand, in the case when the electrolytic plating is used to form the surface abrasive-grain layer 9, the catalyst layer is unnecessary, and hence the pedestal 2 with the intermediate abrasive-grain layer 7 formed thereon may be put into the plating solution immediately after its washing with water, to form the surface abrasive-grain layer 9. The thickness of the surface abrasive-grain layer 9 and the content of the abrasive grains in the abrasive-grain layer may be controlled in the same way as the formation of the intermediate abrasive-grain layer 7.

Thereafter, the pedestal 2 with these layers are taken out of the plating solution and washed with water, and thereafter the masking of the pedestal 2 is removed. Thus, the catalyst layer having the intermediate abrasive-grain layer 7 and the surface abrasive-grain layer 9 is completed. Note, however, that, in the case when the surface abrasive-grain layer 9 is formed by electrolytic plating, the abrasive-grain layer may in some cases be not formed uniformly after the shape of the pedestal 2 surface. Accordingly, it is preferable to make shape correction by mechanical working.

The grindstone 1 of this embodiment having been described above is so made up that the intermediate abrasive-grain layer 7 and the surface abrasive-grain layer 9 may differ in at least one physical properties of both optical characteristics and coefficient of dynamic friction to workpiece. Hence, the optical characteristics may visually be observed or may be measured with a measuring instrument to recognize the boundary 51 between the intermediate abrasive-grain layer 7 and the surface abrasive-grain layer 9. Thus, on the way of grinding or polishing carried out using the grindstone 1, the lifetime of the grindstone 1 can be judged to have come up to an end, because it can be detected that the surface abrasive-grain layer 9 has worn and the intermediate abrasive-grain layer 7 has come exposed. Thus, the grindstone 1 can be replaced before the pedestal 2 comes exposed, so that there is no risk of the pedestal 2 damaging the workpiece. At the same time, the pedestal 2 is also by no means scratched, and hence the pedestal 2 can be reused. Also, the thickness of the intermediate abrasive-grain layer 7 may be set to not less than the thickness that is necessary for one workpiece to be abraded or polished. Thus, even when it has been detected that the intermediate abrasive-grain layer 7 has come exposed, a procedure can be taken in which the working is continued until the working of a workpiece being worked is completed, and thereafter the grindstone 1 is replaced. This enables enhancement of operating efficiency in replacing the grindstone 1.

Incidentally, in this embodiment, the intermediate abrasive-grain layer 7 and the surface abrasive-grain layer 9 have been described which are so made up as to make the color tones of themselves different. However, they may also be so made up that microcapsules enclosing a coloring matter are enclosed in the intermediate abrasive-grain layer 7 together with the abrasive grains 4a. In this case, the surface abrasive-grain layer 9 wear out and the intermediate abrasive-grain layer 7 comes exposed, whereupon the microcapsules crush as a result of working and the coloring matter comes released. Hence, the color tone of waste liquor may be detected by visual observation or with a measuring instrument to recognize that the intermediate abrasive-grain layer 7 has come exposed.

In this embodiment, what has also been described is that the density of abrasive grains is changed in order to change the coefficients of dynamic friction to workpiece of the intermediate abrasive-grain layer 7 and surface abrasive-grain layer 9. However, the layers may also be so made up that the density of abrasive grains in the abrasive-grain layers 7 and 9 change multi-stepwise or continuously from the intermediate abrasive-grain layer 7 in the thickness direction without any clear boundary 51 as the surface abrasive-grain layer 9. In this case, the rotational torque changes multi-stepwise or continuously with the progress of wear of the abrasive-grain layers, and hence the lifetime of the grindstone can be judged to have come to run, at the time when the rotational torque become the one determined beforehand. The grindstone made up in this way brings the effect that, when a plurality of workpieces made of different materials are worked by means of one type of grindstone, the lifetime of the grindstone can be judged even if the intermediate abrasive-grain layer 7 has different thickness depending on the materials of workpieces, as long as the rotational torque at which the lifetime is judged to have come to run is beforehand set for each material of the workpiece.

### EXAMPLE 1

Example 1 of the present invention is described. A grindstone of Example 1 has the structure the grindstone 1 shown in FIG. 1 has, and is a spherical grindstone for working convex lenses, which is commonly called a forming grindstone. The grindstone 1 has the pedestal 2, and the intermediate abrasive-grain layer 7 and the surface abrasive-grain layer 9 which are provided on the pedestal 2. The intermediate abrasive-grain layer 7 is so made up that abrasive grains 4a made of diamond are bound with a black electroless nickel plating film. The surface abrasive-grain layer 9 is so made up that abrasive grains 4b made of diamond are bound with a silver white electroless nickel plating film. The abrasive grains 4a and the abrasive grains 4b both have particle diameters of from 2 to 4 μm. The intermediate abrasive-grain layer 7 has a thickness of about 10 μm, and the surface abrasive-grain layer 9 has a thickness of about 300 μm. The pedestal 2 is made of a brass material. It has a diameter of 30 mm and is so worked as to have a curvature radius R of 20 mm.

How to produce the grindstone 1 of Example 1 is described below.

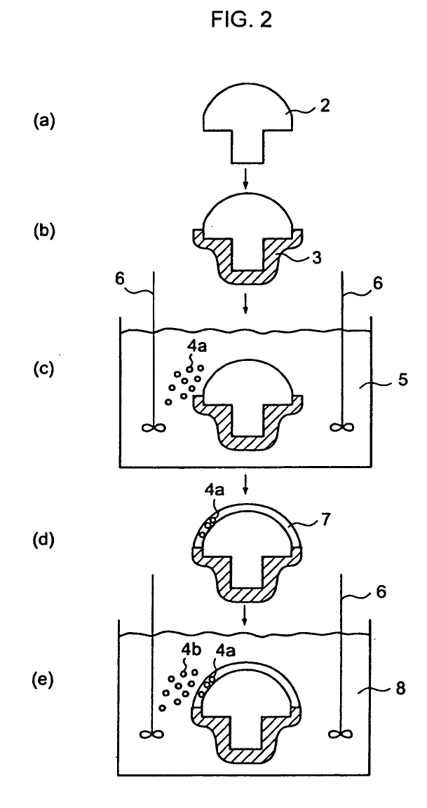

First, the pedestal 2 is prepared, and is degreased with a solvent (FIG. 2 (a)). Thereafter, the pedestal 2 is coated with a maskant on its back and outer round side to form masking 3, followed by drying (FIG. 2 (b)). Next, the pedestal 2 is subjected to alkali degreasing treatment and activation treatment in order, which is thereafter immersed for 60 seconds in a palladium displacement solution composed chiefly of palladium chloride, to form a palladium layer (not shown) at the surface portion of the pedestal. This film serves as the catalyst layer that accelerates the reaction of electroless plating. After the catalyst layer has been formed, this pedestal is put into an electroless nickel plating solution (available from Japan Kanigen Co., Ltd; trade name: KANIBLACK SKZ) 5 which can form a nickel plating film with a color tone of black (FIG. 2 (c)).

0.1% by weight of diamond powder of 2 to 4 μm in particle diameter which is to afford the abrasive grains 4a is put into the electroless nickel plating solution 5, followed by stirring by means of a stirrer 6. Stirring conditions are set to conditions beforehand determined in order to incorporate the abrasive grains 4a in the plating film in the desired quantity. The plating solution has a temperature of 90° C. In this solution, plating is carried out for 1 hour to make a black nickel plating film deposited in a thickness of 10 μm which has been incorporated with the abrasive grains 4a. This film is the intermediate abrasive-grain layer 7 (FIG. 2 (d)).

Thereafter, the pedestal 2 with the intermediate abrasive-grain layer 7 formed thereon is washed with water, and then put into an electroless nickel plating solution 8 which can form a nickel plating film with a color tone of silver white (FIG. 2 (e)). As the plating solution 8, any of the electroless plating solutions shown in Table 1 is used. Then, 0.1% by weight of diamond powder of 2 to 4 μm in particle diameter which is to afford the abrasive grains 4b is put into the electroless nickel plating solution 8, followed by stirring by means of a stirrer 6. Stirring conditions of the stirrer 6 are set to conditions beforehand kept determined in order to incorporate the abrasive grains 4b in the plating film in the desired quantity. The plating solution has a temperature of 90° C. In this solution, plating is carried out for 16 hours to make a silver white nickel plating film deposited in a thickness of 300 μm which has been incorporated with the abrasive grains 4b. This film is the surface abrasive-grain layer 9. After the plating, the pedestal 2 with these layers are taken out of the plating solution 8 and washed with water, followed by drying, and then the masking 3 is removed. Thus, a grindstone 1 of 30 mm in diameter and 20 mm in curvature radius R is completed (FIG. 1).

### EXAMPLE 2

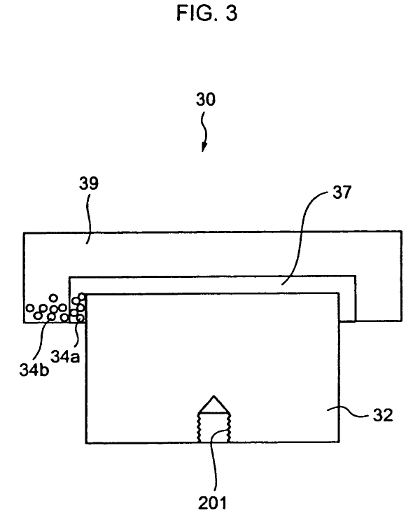

A grindstone 30 of Example 2, which is illustrated in FIG. 3, is a flat grindstone which is commonly called a pellet type. This grindstone 30 has a pedestal 32, and an intermediate abrasive-grain layer 37 and a surface abrasive-grain layer 39 which are provided on the pedestal 32. The intermediate abrasive-grain layer 37 is a layer in which abrasive grains 34a made of diamond are bound with a silver white electroless nickel plating film as a binder. The surface abrasive-grain layer 39 is a layer in which abrasive grains 34b made of diamond are bound with a brown electrolytic nickel plating film. The abrasive grains 34a and the abrasive grains 34b both have particle diameters of from 4 to 6 μm. The pedestal 32 is made of aluminum, and has a disklike shape of 15 mm in diameter and 5 mm in thickness. A threaded hole 201 is beforehand provided on the back of the pedestal 32.

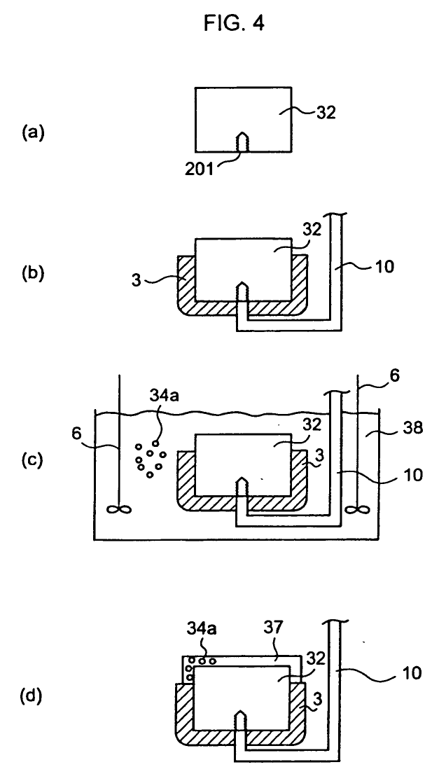

First, the pedestal 32 is degreased with a solvent (FIG. 4 (a)), and thereafter an electrolytic plating electrode 10 is attached to the threaded hole 201 on the back of the pedestal 32. Then, the pedestal 32 is coated with a maskant on its back and on its outer round side up to about a half in the thickness direction to form masking 3, followed by drying (FIG. 4 (b)). Next, the pedestal 2 is subjected to alkali degreasing treatment and activation treatment in order, which is thereafter immersed for 30 seconds in a zinc displacement solution to form a zinc layer (not shown) on the top surface of the pedestal 32 and on the part where the aluminum face stands exposed on the outer round side. This film serves as the catalyst layer that accelerates the reaction of electroless plating.

After the catalyst layer has been formed, this pedestal is put into an electroless nickel plating solution 38 with which a color tone of silver white can be obtained (FIG. 4 (c)) As the plating solution 38, any of the electroless plating solutions shown in Table 1 is used. Then, 0.2% by weight of diamond powder of 4 to 6 μm in particle diameter which is to afford the abrasive grains 4a is put into the electroless nickel plating solution 38, followed by stirring by means of a stirrer 6. Stirring conditions are set to conditions beforehand kept determined in order to incorporate the abrasive grains 4a in the plating film in the desired quantity. The plating solution has a temperature of 90° C. In this solution, plating is carried out for 1 hour to make a silver white nickel plating film deposited in a thickness of 15 μm which has been incorporated with the abrasive grains 4a. This film is the intermediate abrasive-grain layer 37 (FIG. 4 (d)).

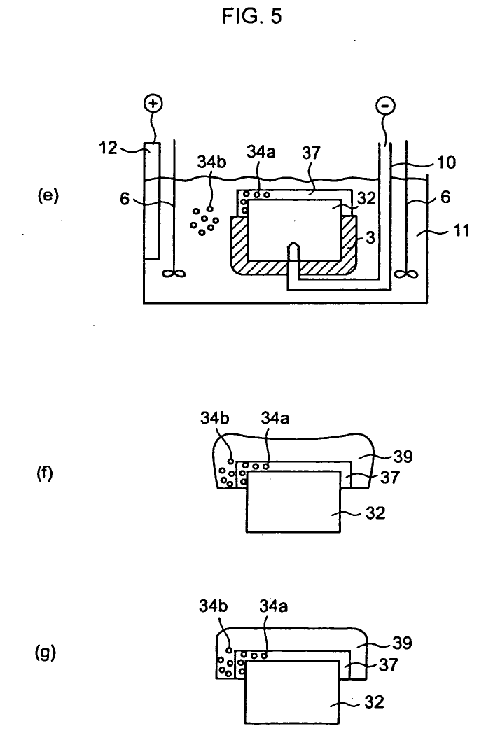

Thereafter, the pedestal 32 with the intermediate abrasive-grain layer 37 formed thereon is washed with water, and then put into an electrolytic copper plating solution 11 which can form a copper plating film with a color tone of brown. As the plating solution 11, any of the electroless plating solutions shown in Table 1 is used. Here, a direct-current power source is connected on its cathode side to the electrolytic plating electrode 10, and is connected on its anode side to a copper electrode 12 disposed in the plating bath (FIG. 5 (e)). Then, 0.2% by weight of diamond powder of 4 to 6 μm in particle diameter which is to afford the abrasive grains 34a is put into the electroless nickel plating solution 11, followed by stirring by means of a stirrer 6. Stirring conditions of the stirrer 6 are set to conditions beforehand kept determined in order to incorporate the abrasive grains 34b in the plating film in the desired quantity. The plating solution has a temperature of 40° C. A direct-curent electric current is flowed across the electrode 10 and the electrode 12 at a rate of 5 amperes per 100 square centimeter. Plating is carried out for 16 hours to make a silver white nickel plating film deposited in a thickness of about 1 mm which has been incorporated with the abrasive grains 34b (FIG. 5 (f)). This film is the surface abrasive-grain layer 39. After the plating, the pedestal 2 with these layers are taken out of the plating solution and washed with water, followed by drying, and then the electrolytic plating electrode 10 and the masking 3 are removed. Thereafter, the surface of the surface abrasive-grain layer 39 is face-corrected by mechanical working such as sanding, thus the grindstone 30 is completed (FIG. 5 (g)).

### EXAMPLE 3

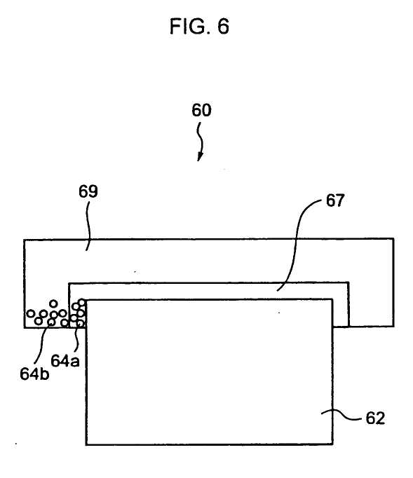

A grindstone of Example 3 has a structure shown in FIG. 6, and is, like Example 2, a flat grindstone which is commonly called a pellet type. Accordingly, like Example 2, this grindstone 60 also has a pedestal 62, and an intermediate abrasive-grain layer 67 formed on the pedestal 62, and a surface abrasive-grain layer 69 further formed thereon. The intermediate abrasive-grain layer 67 and the surface abrasive-grain layer 69 are both so made up that abrasive grains 64a and 64b made of diamond of 2 to 3 μm in particle diameter are bound with silver white electroless nickel plating films as binders. Here, the diamond abrasive grains 64a of the intermediate abrasive-grain layer 67 are in a content of 30% by volume, whereas the diamond abrasive grains 64b of the surface abrasive-grain layer 69 are in a content of 15% by volume. Also, the intermediate abrasive-grain layer 67 has a thickness of about 15 μm, and the surface abrasive-grain layer 69 has a thickness of about 350 μm. The pedestal 62 is made of an aluminum material, and is 30 mm in diameter and 4 mm in thickness.

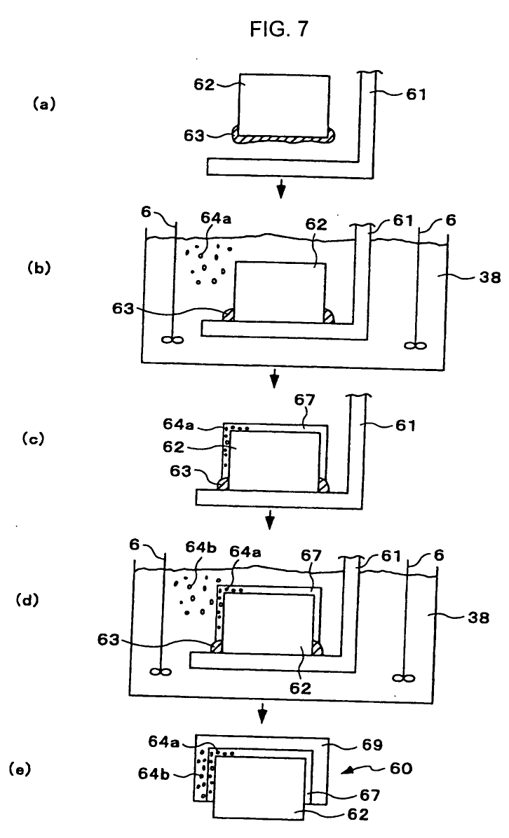

How to produce the grindstone 60 of this Example 3 is described below with reference to FIG. 7.

First, the above pedestal 62 is degreased with a solvent, and thereafter the pedestal 62 is coated with a maskant 63 on its back to form masking 63. This pedestal is placed on a plating jig 61 (FIG. 7 (a)). Thereafter, the maskant 63 is dried for a certain time to make the pedestal 62 fastened onto the plating jig 61. Next, the surface of the pedestal 62 is subjected to alkali degreasing and activation in order. This pedestal 62 is thereafter immersed for 30 seconds in a zinc substitution solution to form a zinc layer (not shown) on the top surface of the pedestal 62 and on the part where the aluminum face stands exposed on the outer round side. This zinc film serves as the catalyst layer that accelerates the reaction of electroless plating.

Then, the pedestal 62 on which the catalyst layer has been formed is put into an electroless plating solution 38 incorporated with the diamond abrasive grains 64a (FIG. 7 (b)). This electroless plating solution 38 is the same one as the electroless plating solution used to form the surface abrasive-grain layer 9 in Example 1, and is heated to 90° C. As the abrasive grains 64a, 0.2% by weight of diamond powder of 2 to 3 μm in particle diameter is put into the electroless nickel plating solution 38. Conditions for stirring carried out by means of a stirrer 6 are conditions under which the abrasive grains 64a are incorporated in the plating film in the desired quantity (30% by volume in this Example). Under the above conditions, plating is carried out for 1 hour to make an electroless plating film deposited in a thickness of 15 μm on the catalyst layer of the pedestal 62. This electroless plating film forms the intermediate abrasive-grain layer 67 (FIG. 7 (c)).

Thereafter, the pedestal 62 with the intermediate abrasive-grain layer 67 formed thereon is washed with water, and then again put into the electroless nickel plating solution 38 incorporated with diamond abrasive grains 64b (FIG. 7 (d)). This electroless plating solution 38 is the same one as the electroless plating solution used in forming the intermediate abrasive-grain layer 67. Accordingly, the washing with water may simply be carried out. In addition, this enables prevention of faulty plating deposition that may occur when a plating solution different in type has been mingled. Into this electroless plating solution 38, diamond powder of 2 to 3 μm in particle diameter which is the same one as the electroless plating solution used in forming the intermediate abrasive-grain layer 67 is kept put as the abrasive grains 64b, which, however, is put into it in an amount of 0.05% by weight. Conditions for stirring carried out by means of a stirrer 6 are conditions under which the abrasive grains 64b are incorporated in the plating film in the desired quantity (15% by volume in this Example). The plating solution 38 has a temperature of 90° C., and plating is carried out for 3 hours to make an electroless plating film deposited in a thickness of 45 μm on the intermediate abrasive-grain layer 67. This electroless plating film forms the above surface abrasive-grain layer 69.

After the surface abrasive-grain layer 9 with the desired thickness has been formed, the pedestal 62 with abrasive-grain layers formed thereon is taken out of the plating solution 38 together with the jig 61, and this is washed with water, followed by drying. Thereafter, the masking 63 is removed, and the pedestal 62 with abrasive-grain layers is detached from the plating jig 61. Then, the surface of the surface abrasive-grain layer 69 is face-corrected by mechanical working such as sanding, thus the grindstone 60 is completed (FIG. 7 (e)).

Next, a performance test was conducted on the grindstone 60 produced as described above, which was as described below.

In this performance test, one hundred and fifty pieces of the above grindstone 60 were bonded to a flat base plate of 380 mm in diameter. Using this, the relationship between working rate (depth of wear in the thickness direction of a workpiece) and depth of wear of the surface abrasive-grain layer 69 at intervals of 2 minutes was examined under working conditions shown below.
Material of workpiece: Quartz (SiO₂).
Shape and size of workpiece: In the shape of a disk of 270 mm in diameter, and working surface is flat.
Grinding machine: An oval motion type manufactured by Tateno. Number of revolutions of grindstone: 250 rpm.
Number of revolutions of workpiece: 50 rpm.
Gauge pressure: 0.3 MPa. Grinding solution: A solution prepared by diluting an aqueous solution type grinding stock solution with water (grinding stock solution: water=1:10).

In this performance test, as shown in Table 4 below, the working rate was substantially stable at the 40 μm mark just before a surface abrasive-grain layer 69 of about 45 μm in thickness comes substantially worn (No. 14). However, after the surface abrasive-grain layer 69 has substantially worn (No. 15), the working rate was seen to have greatly lowered.

TABLE 4

| | Working rate (μm) | Abrasive-grain |
|---|---|---|
| | (Depth of abrasion in thickness direction of | layer wear depth |
| | workpiece at intervals of 2 minutes) | (μm) |
| 1 | 47 | 1 |
| 2 | 43 | Not measured |
| 3 | 39 | Not measured |
| 4 | 43 | 12 |
| 5 | 41 | Not measured |
| 6 | 42 | Not measured |
| 7 | 45 | 21 |
| 8 | 46 | Not measured |
| 9 | 47 | Not measured |
| 10 | 44 | Not measured |
| 11 | 43 | 34 |
| 12 | 45 | Not measured |
| 13 | 43 | Not measured |
| 14 | 48 | Not measured |
| 15 | 36 | 45 |
| 16 | 30 | Not measured |
| 17 | 21 | 46 |
| 18 | 14 | Not measured |
| 19 | 4 | 46 |

This phenomenon is considered to be due to the following.

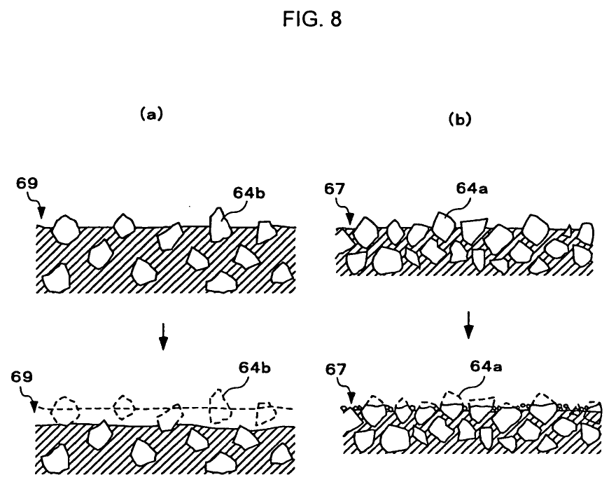

In the case of the surface abrasive-grain layer 69, as shown in FIG. 8 (a), the mutual spaces between abrasive grains 64b and 64b are relatively wide, and hence grinding dust of the abrasive grains 64b and binder plating film are appropriately discharged in the course of grinding. On the other hand, in the case of the intermediate abrasive-grain layer 67, as shown in FIG. 8 (b), the mutual spaces between abrasive grains 64a and 64a are relatively narrow, and hence grinding dust of the abrasive grains 64a and binder plating film are drained with difficulty in the course of grinding, and such grinding dust may gather in small hollows of a ground surface to come into clogging. Hence, in the grinding in which this intermediate abrasive-grain layer 67 has participated, the working rate has lowered and, in the working carried out in the state the intermediate abrasive-grain layer 67 has completely come exposed, it has also been observed that the workpiece slips on the whetstone without grinding.

As shown above, in this Example 3, the intermediate abrasive-grain layer 67 is made to have a coefficient of dynamic friction extremely smaller than the surface abrasive-grain layer 69 by providing clogging conditions under which this intermediate abrasive-grain layer 67 causes the clogging in an attempt to work the workpiece with the intermediate abrasive-grain layer 67, namely, by incorporating in the silver white electroless nickel plating film 30% by volume of the diamond abrasive grains 64a of 2 to 3 μm in particle diameter.

Accordingly, a rotational-torque measuring instrument may be kept installed at the rotatingly driving part of the workpiece being rotated or at the rotatingly driving part of the grindstone being rotated. Thus, when the surface abrasive-grain layer 69 runs out and the intermediate abrasive-grain layer 67 comes exposed, with an extreme lowering of coefficient of dynamic friction of the surface, a great lowering of rotational torque is measured, and the lifetime of the grindstone may be judged from the results of this measurement.

Incidentally, after the working rate was seen to have greatly lowered, the workpiece was observed to find that no scratch was seen at all on its surface. This is considered due to the fact that the intermediate abrasive-grain layer 67 has come to have a very smooth surface shape as a result of the clogging of its surface.

As described above, the grindstones 1 and 30 of Examples 1 and 2 have the intermediate abrasive-grain layers 7 and 37 having color tones different from those of the surface abrasive-grain layers 9 and 39. Hence, even when the surface abrasive-grain layers 9 and 39 have worn out during the working of a workpiece, the fact that the intermediate abrasive-grain layers 7 and 37 have come exposed can be detected by color tones by visual observation or with a measuring instrument. Also, in the grindstone 6b of Example 3, the intermediate abrasive-grain layer 67 has a very small coefficient of dynamic friction compared with the surface abrasive-grain layer 69. Hence, even when the surface abrasive-grain layer 69 has worn out during the working of a workpiece, the fact that the intermediate abrasive-grain layer 67 has come exposed can be detected by changes in working rate or by changes in rotational torque of the grindstone 60. Thus, in any grindstones of Examples 1, 2 and 3, it can simply be judged that the lifetime of the grindstones has come up to an end, and the grindstones can surely be replaced. Incidentally, the intermediate abrasive-grain layers 7, 37 and 67 function as grindstones, and hence they can prevent workpieces from being scratched or broken. Also, the pedestals 2, 32 and 62 themselves are not scratched, and can be reused.

Now, in the grindstone making use of a resin bond or a metal bond as a binder, mentioned in the column BACKGROUND ART, the lifetime of the grindstone is so short that the ground surface of a workpiece is observed, e.g., at a stage it has been ground once, where the ground surface is corrected if it has deformed. Accordingly, in such a grindstone, the ground surface must frequently be observed. Moreover, since the whole of the grindstone in its thickness direction is held by the abrasive-grain layer, it can substantially surely be judged that the lifetime of the grindstone has come up to an end.

However, in the grindstones shown in the above First Embodiment and its Examples 1, 2 and 3, the abrasive-grain layer is formed of the plating films formed on the pedestal made of a metal. Hence, it is difficult to see the boundary between the abrasive-grain layer and the pedestal, and it is difficult to recognize the decrease in thickness of the abrasive-grain layer. In addition, the abrasive-grain layers formed of the plating films are hard and has a long lifetime. In particular, the abrasive-grain layers formed of electroless plating films are very hard and has a very long lifetime. Hence, there is a tendency of grinding a large number of workpieces without any operation of correction like that in the resin bond grindstone, so that the opportunity of observing the ground surface is extremely fewer than in the resin bond grindstone. Accordingly, it is very useful that the lifetime can surely be judged in regard to those in which, like the grindstones shown in the above First Embodiment and its Examples 1, 2 and 3, the abrasive-grain layers are formed of the plating films.

### Second Embodiment

Second Embodiment according to the present invention is described below.

This embodiment is a working tool in which the grindstone described in the above embodiment is used in a large number.

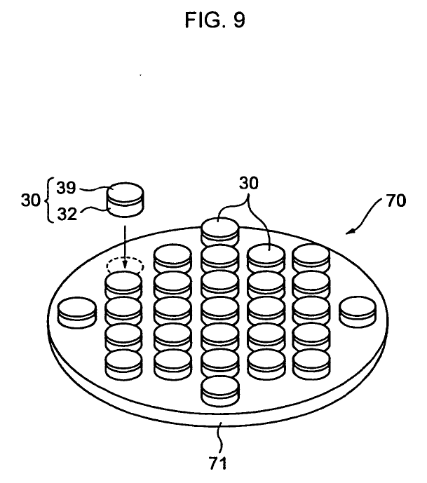

Stated specifically, as shown in FIG. 9, a working tool 70 of this embodiment is one in which, e.g., grindstones 30 of Example 2 described previously are attached onto a disklike base plate 71. That is, this working tool 70 is one in which what has been dealt as the grindstone in the above Embodiment and Examples 1 are dealt as a grindstone pellet and this grindstone pellet is attached to the base plate 71 in a large number to set up a grindstone.

In such a working tool 70, its working surface is required to have a reverse shape of the intended working shape. Accordingly, in the following, there is a description which is a method for producing a working tool 70 whose working surface has the reverse shape of the intended working shape. Incidentally, in the following description, the intended working shape is a convex shape, and the working surface has a concave shape, which is the reverse shape of the former.

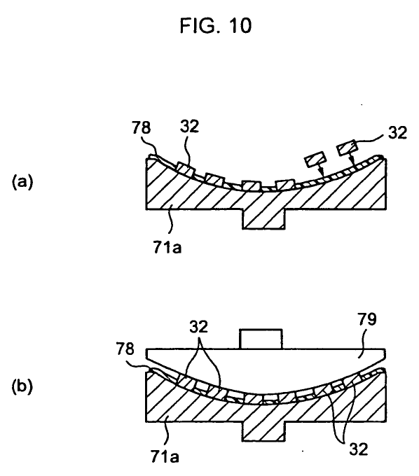

To begin with, a first production process is described with reference to FIGS. 10(a) and (b).

In this production process, one whose surface has a reverse shape of the intended face shape is prepared as a base plate 71a. Then, on the surface of this base plate 71a, the pedestal 32 of the grindstone 30 is bonded with an adhesive 78 or the like in a large number (FIG. 10 (a)) At this point of time, the shape in which the surfaces of a large number of pedestals 32 are chained stands substantially the reverse shape of the intended face shape. Here, the surfaces of a large number of pedestals 32 are further ground with a spotting plate 79 to shape them so that the shape in which the surfaces of a large number of pedestals 32 are chained may stand accurately the reverse shape of the intended face shape (FIG. 10 (b)).

Thereafter, intermediate abrasive-grain layers and surface abrasive-grain layers are formed on the large number of pedestals in the manner described in the above embodiment.

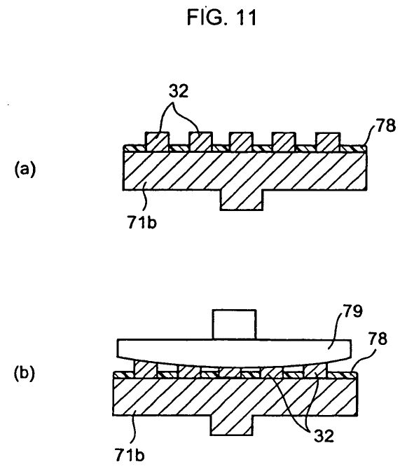

A second production process is described below with reference to FIGS. 11 (a) and (b).

In this production process, as being different from the first process, a base plate 71b having a flat surface is prepared. Then, on the surface of this base plate 71b, the pedestal 32 of the grindstone 30 is bonded with an adhesive 78 or the like in a large number (FIG. 11 (a)).

Next, the surfaces of a large number of pedestals 32 bonded onto the base plate 71b are ground with a spotting plate 79 to shape them so that the shape in which the surfaces of a large number of pedestals 32 are lined may stand the reverse shape of the intended face shape (FIG. 11 (b)).

Thereafter, intermediate abrasive-grain layers and surface abrasive-grain layers are formed on the large number of pedestals in the manner described in the above embodiment.

### Third Embodiment

Third Embodiment according to the present invention is described below.

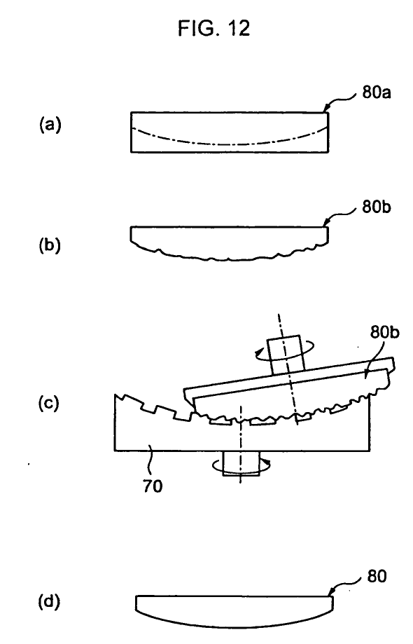

This embodiment is a method for producing an optical element by using the grindstone described above. Here, a method for producing a convex-shaped optical element by using the working tool (grindstone) 70 described in Second Embodiment is described with reference to FIGS. 12 (a) and (b).

First, as shown in FIG. 12 (a) and (b), the shape of a workpiece 80a is shape-produced in order to make it close to that of an optical element 80. Next, as shown in FIG. 12 (c), the surface of the workpiece is ground by means of the working tool 70 to obtain such an optical element 80 as shown in FIG. 12 (d). In this case, in this embodiment, as the working tool 70 is rotated, the workpiece is also rotated.

As a material for this optical element, any material may basically be used as long as it fits to the intended optical characteristics. For example, since in many cases a short-wavelength ArF laser or F₂ laser is used as a light source in order to project a fine pattern on a silicone wafer, quartz or fluorite is employed in various optical elements of such a projection optical system in order to deal with light having short wavelength. It has been ascertained by various tests that, where such quartz or fluorite is used as a material for the optical element, it is very preferable to use the grindstone making use of plating films, in particular, electroless plating films as binders for abrasive grains. Hence, in the case when quartz or fluorite is used as a material for the optical element, it is effective to use the grindstones of First Embodiment and its Examples 1, 2 and 3, described above, and also the working tool of Second Embodiment.

### Fourth Embodiment

Fourth Embodiment according to the present invention is described below.

This embodiment is a method for producing a projection exposure device by using the grindstone described above.

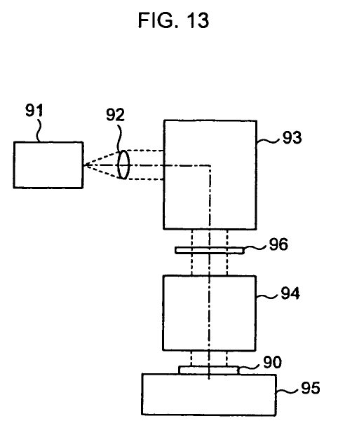

The projection exposure device in this embodiment is, as shown in FIG. 13, a device which projects a pattern on a silicon wafer 90, and has a light source 91, a collective lens 92, an illumination optical system 93, a projection optical system 94, and a stage 95 on which the silicon wafer 90 is to be placed. Between the illumination optical system 93 and the projection optical system 94, a reticle 96 is appropriately disposed in which a pattern corresponding to what is to be worked on the silicon wafer 90 has been formed. As the light source 91, used in this embodiment is an ArF laser which emits light having a very short wavelength or an F₂ laser which emits light having a much shorter wavelength. The illumination optical system 93 has the function to uniform optical-intensity distribution in the optical path.

In order to project an ultra-fine pattern on the silicon wafer 90, projection exposure devices available in recent years are demanded to project the pattern of the reticle 96 by using light having a shorter wavelength as stated above. Accordingly, in this embodiment, in order to deal with the light having short wavelength, various lenses in the collective lens 92 and illumination optical system 93 and various lenses in the projection optical system 94 are all made of quartz or fluorite.

Now, various tests made by the present inventors have ascertained that, in the grinding of the quartz or fluorite, very good results are obtainable when the working tool (grindstone) 70 of Second Embodiment is used in the manner as described in Third Embodiment. Stated specifically, the grinding rate can dramatically be improved. Also, since the lifetime of the working tool (grindstone) 70 can be known with ease, glass materials such as quartz and fluorite can be prevented from being carelessly scratched by the pedestal 32 in the course of grinding, and the yield can be made higher. In addition, inasmuch as workpieces are ground by the surface abrasive-grain layer 39 formed of the electroless plating film incorporated with diamond abrasive grains, the glass materials such as quartz and fluorite can be ground in a high precision and in a good state, and the production cost of devices themselves can be reduced.

1-13. (canceled)

14. A method for producing an optical element by working a workpiece comprising steps of:
a step of preparing a workpiece and a step working said workpiece by a grindstone;
wherein said grindstone has a pedestal, an abrasive-grain layer provided on the pedestal and formed of a plating film containing abrasive grains, and an intermediate layer provided between the pedestal and the abrasive-grain layer and having physical properties different from those of the abrasive-grain layer; and
said physical properties being inclusive of coefficient of dynamic friction to the workpiece and optical characteristics.

15. The method for producing an optical element according to claim 14, wherein;
said plating film of said abrasive-grain is formed of an electroless plating film.

16. The method for producing an optical element according to any one of claims 14 and 15, wherein;
said workpiece comprises fluorite or quartz.

17. A method for producing a projection exposure device having an optical system comprising at least a lens comprising steps of:
a step of preparing a lens material;
a step of working said lens material by a grindstone, and
a step of setting the worked lens material for structuring an optical system,
wherein said grindstone has a pedestal, an abrasive-grain layer provided on the pedestal and formed of a plating film containing abrasive grains, and an intermediate layer provided between the pedestal and the abrasive-grain layer and having physical properties different from those of the abrasive-grain layer; and
said physical properties being inclusive of coefficient of dynamic friction to said lens material and optical characteristics.

18. The method for producing a projection exposure device according to claim 17, wherein;
said plating film of said abrasive-grain is formed of an electroless plating film.

19. The method for producing a projection exposure device according to any one of claims 17 and 18, wherein;
said lens material is fluorite or quartz.

20. The method for producing an optical element according to claims 14 or 15 wherein;
said intermediate layer includes a plating film which contains abrasive grains, and the plating film is formed so that at least one of the particle diameter and the density of the abrasive grains provides clogging conditions under which said intermediate layer causes clogging when a workpiece is worked with said intermediate layer.

21. The method for producing an optical element according to claims 14 or 15 wherein;
said intermediate layer contains more abrasive grains than the plating film of the abrasive-grain layer.

22. The method for producing a projection exposure device according to claims 17 or 18 wherein;
said intermediate layer includes a plating film which contains abrasive grains, and the plating film is formed so that at least one of the particle diameter and the density of the abrasive grains provides clogging conditions under which said intermediate layer causes clogging when a workpiece is worked with said intermediate layer.

23. The method for producing a projection exposure device according to claims 17 or 18 wherein;
said intermediate layer contains more abrasive grains than the plating film of the abrasive-grain layer.
